(19) United States
(12) Patent Application Publication
(10) Pub. No.: US 2004/0069066 A1
(43) Pub. Date: Apr. 15, 2004

(54) Method for the ultrasound measuring of layer thicknesses of cladding tubes for nuclear fuel

(76) Inventor: Martin Dust, Erlangen (DE)

Correspondence Address: LERNER AND GREENVERG,P.A., POST OFFICE BOX 2480, HOLLYWOOD, FL, 33022-2480, US

(21) Appl. No.: 10/673,961

(22) Filed: Sep. 29, 2003

Related U.S. Application Data
(63) Continuation-in-part of application No. PCT/EP02/02888, filed on Mar. 15, 2002.

(51) Int. Cl. G01B 17/02

(52) U.S. Cl. 73/602; 73/627; 73/644

(57) ABSTRACT

A method for ultrasound measurement of the layer thickness of thin-walled tubes includes utilizing a high-frequency probe (more than 40 MHz) with a coupling area having a planar area surface. The area surface is coupled to the tube surface that is wetted with a coupling agent by way of a contact method. The inventive method is used for duplex or liner layers of 0.15 mm thickness of reactor fuel cladding tubes.

### CROSS-REFERENCE TO RELATED APPLICATION

This application is a continuation of copending International Application No. PCT/EP02/02888, filed Mar. 15, 2002, which designated the United States and was not published in English.

### BACKGROUND OF THE INVENTION

### FIELD OF THE INVENTION

The invention relates to a method for the ultrasound measuring of the thickness of layers of cladding tubes for nuclear fuel. Such tubes have a wall thickness of 1 mm and smaller. Externally or internally they are provided with multiple duplex or liner layers. The thickness of liner layers is frequently 0.15 mm and smaller.

U.S. Pat. No. 4,918,989 to Desruelles et al. describes a method for determining the liner layer thickness of a cladding tube for nuclear fuel in which the sound is launched across an initial water path in an immersion technique. However, only liner layer thicknesses above 0.4 mm can be determined with sufficient accuracy by the disclosed method.

### SUMMARY OF THE INVENTION

It is accordingly an object of the invention to provide a method for the ultrasound measuring of layer thicknesses of cladding tubes for nuclear fuel that overcomes the hereinafore-mentioned disadvantages of the heretofore-known devices and methods of this general type and that provides an ultrasound technique with which the thickness of sublayers of thin-walled tubes can be determined with a high level of measurement accuracy.

With the foregoing and other objects in view, there is provided, in accordance with the invention, a method for the ultrasound measuring of layer thicknesses in cladding tubes for nuclear fuel, including the steps of providing a high-frequency probe with a coupling surface having a planar surface region, wetting the tube with a coupling medium, and coupling the planar surface region with a wetted surface of the tube by a contact technique.

With the objects of the invention in view, there is also provided a method for the ultrasound measuring of layer thicknesses, including the steps of providing a high-frequency probe with a coupling surface having a planar surface region, wetting a nuclear fuel cladding tube with a coupling medium, coupling the planar surface region with a wetted surface of the cladding tube by a contact technique, and measuring a thickness of a liner layer of the cladding tube.

With the objects of the invention in view, there is also provided a method for the ultrasound measuring of layer thicknesses in cladding tubes for nuclear fuel, including the step of coupling, by a contact technique, a planar surface region of a coupling surface of a high-frequency probe with a tube surface wetted with a coupling medium.

According to the invention, a high-frequency probe (HF probe) having a coupling surface with a planar surface region is utilized, the surface region being coupled with the tube surface, which is wetted with a coupling medium, by a contact technique. The utilization of high-frequency ultrasound for measuring purposes is, basically, known, but it has not yet been employed for determining the layer thickness of cladding tubes for nuclear fuel. Previously, the coupling has occurred by immersion or puddle techniques. The utilization of high-frequency ultrasound, i.e., ultrasound of greater than 40 MHz, is impossible with this type of coupling because water transmits such sound frequencies poorly. Probes for ultrasound testing on tubes wherein the coupling surface includes a curvature corresponding to the tube surface are known from the article “Ultraschallprüfung” (Springerverlag, Berlin Heidelberg 1997: 239-241). If such probes were used for the measurement task in question, an extremely exact and expensive matching of the curvature surfaces that are to be contacted with one another would be required in order to prevent the emergence of gaps and, thus, the emergence of disturbing echo signals. On the other hand, such an effect is prevented by the use of a probe having a coupling surface with a planar region or a probe having a planar overall coupling surface. The sound irradiation occurs only across a narrow, approximately rectangular surface region formed by the direct material contact between the probe and the surface of the tube. Sound waves that are emitted outside this region are removed from the radiation path by reflection at the curved tube surface and deflected out radially by refraction at the tube surface and, therefore, do not generate any echo signals that are detectable by the probe. A further advantage of the proposed method is that one and the same probe can be used for measuring tubes of different diameters. In comparison, probes with curved coupling surfaces would be suited to only one specific tube diameter. For such probes, it is also problematic that tubes can include different surfaces at different measuring points. In contrast, in the inventive method, the quality of the tube surface is of secondary importance because the coupling surface is a narrow rectangle.

Due to the coupling region being very narrow, only a portion of the transmission impulse that is generated by the oscillator of the probe is available for measuring purposes. Accordingly, the received echo signals have a reduced intensity.

In accordance with another mode of the invention, a resulting unfavorable signal/noise ratio can be improved by the application of digital recording and processing methods, for instance, the superimposing of echo impulse sequences. Echo signals received by the probe can be recorded in digital form and a signal/noise ratio of the recorded digital echo signals is improved by digitally processing the recorded digital echo signals.

In accordance with a further mode of the invention, the tube wetting step is carried out by wetting a tube having a wall thickness no greater than 1 mm.

In accordance with a concomitant mode of the invention, there is provided the step of measuring a thickness of a liner layer of a nuclear fuel cladding tube selected from the group consisting of an inner liner layer and an outer liner layer, the thickness of the liner layer being approximately 0.15 mm.

Other features that are considered as characteristic for the invention are set forth in the appended claims.

Although the invention is illustrated and described herein as embodied in a method for the ultrasound measuring of layer thicknesses of cladding tubes for nuclear fuel, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block circuit diagram of a device for measuring the layer thickness of a thin-walled cladding tube for nuclear fuel according to the invention; and

FIG. 2 is a diagrammatic illustration of an enlarged detail of FIG. 1 representing a cladding tube and a probe.

### DESCRIPTION OF THE PREFERRED EMBODIMENTS

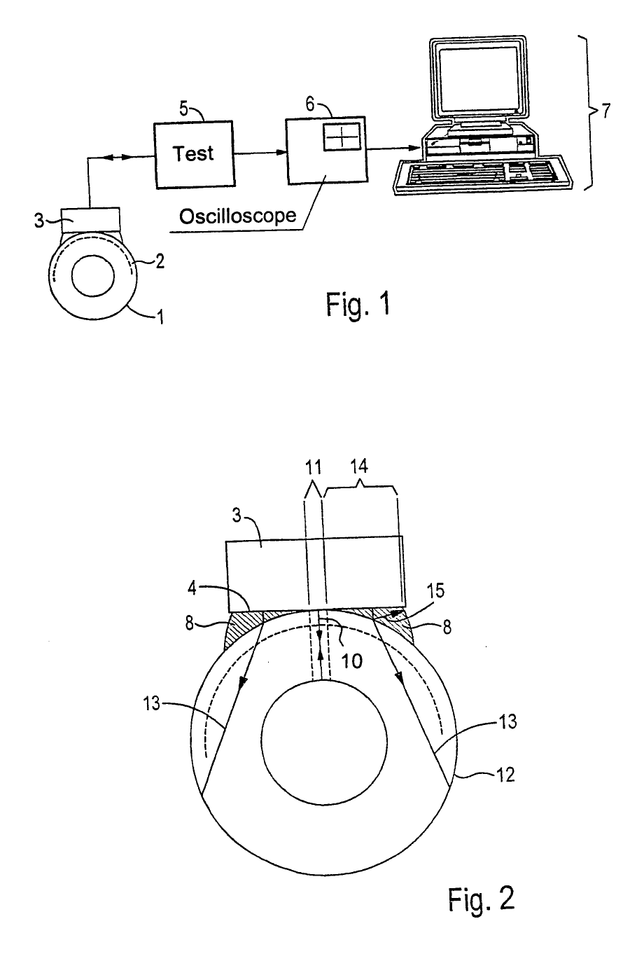

Referring now to the figures of the drawings in detail and first, particularly to FIG. 1 thereof, there is shown a device for a method for the ultrasound measurement of a cladding tube 1 for nuclear fuel. The cladding tube 1 has a diameter of 10 mm and a wall thickness of 0.6 mm. The cladding tube is provided with an external liner layer 2, for example. The cladding tube 1 and the liner layer 2 with a maximum thickness of 0.15 mm are of zirconium alloys that differ in composition and, thus, in sound impedance. Disposed on the surface of the tube is an ultrasound probe 3 with a plane coupling surface 4. The echo signals that are received by the ultrasound probe 3 are picked up by an ultrasound testing device 5 and recorded as an HF image by a digital oscilloscope 6. A DP system, for instance, a PC 7, is connected to the oscilloscope 6 for processing the data of the HF image.

The coupling of the probe 3 to the tube surface is accomplished by contacting, the surface of the tube being wetted with a conventional coupling medium 8 such as water, oil, or glycerin.

As emerges from FIG. 2, the evaluatable sound beam 10 is limited to a narrow region defined by the contact surface 11 between the tube surface 12 and the coupling surface 4.

The gaps 14 adjoining the contact surface 11 exteriorly on either side are similarly filled with coupling medium 8 at least to a defined extent, which can hardly be avoided for practical reasons. These gaps 14 cause the emergence of basically disturbing echoes signals, which can impair the layer thickness measurement. These disturbances are strongly dampened by the selected geometry of a planar coupling surface 4. Due to the tube surface 12 curvature, an ultrasound ray 15 that is irradiated outside the contact surface 11 is not reflected back to its starting point again. The long “ringing” that is known to occur in coplanar gaps does not occur. However, such a negative effect can occur in probes with a contact surface that is adapted to the tube curvature.

By virtue of the geometry, which is defined by the planar coupling surface 4 and the curved tube surface 12, a sound wave 13 that is emitted outside the contact surface 11 and broadened into the gaps 14 by the relatively long coupling medium path, and that is, thus, not suitable for the measuring task, is deflected out radially and so does not generate an echo signal that would disturb the measuring result. The coupling medium does not adversely affect the sound coupling in the region of the contact surface 11 because the material is practically exclusively in direct contact there and the coupling medium fills substantially only the microscopic voids that emerge due to the roughness of the surfaces that are in contact. But these voids do not disturb the sound coupling because their dimensions are far below a wavelength of the HF ultrasound.

Of course, the method can also be applied for measuring the overall tube wall thickness. Besides this, the layer thicknesses of multi-layered tubes can, of course, also be measured with the proposed method.

Because the evaluatable sound beam 10 is narrowly limited, the received echoes are correspondingly weak. But the electronic noise can be filtered out by the homologous superposition of multiple ultrasound shots with the aid of digital signal processing techniques. In addition, noise signals that are caused by incomplete dampening of the probe or by transversal waves can be suppressed or at least reduced by the cited technique, which can improve the signal/noise ratio.

I claim:

1. A method for the ultrasound measuring of layer thicknesses in cladding tubes for nuclear fuel, which comprises:
providing a high-frequency probe with a coupling surface having a planar surface region;
wetting the tube with a coupling medium; and
coupling the planar surface region with a wetted surface of the tube by a contact technique.

2. The method according to claim 1, wherein the coupling surface has an overall planar shape.

3. The method according to claim 1, wherein the coupling surface is substantially planar over its entire surface.

4. The method according to claim 1, which further comprises recording echo signals received by the probe in digital form and improving a signal/noise ratio of the recorded digital echo signals by digitally processing the recorded digital echo signals.

5. The method according to claim 1, which further comprises digitally recording echo signals received by the probe and digitally processing the recorded digital echo signals to improve a signal/noise ratio of the recorded digital echo signals.

6. The method according to claim 1, which further comprises carrying out the tube wetting step by wetting a tube having a wall thickness no greater than 1 mm.

7. The method according to claim 1, which further comprises measuring a thickness of a liner layer of a nuclear fuel cladding tube selected from the group consisting of an inner liner layer and an outer liner layer, the thickness of the liner layer being approximately 0.15 mm.

8. A method for the ultrasound measuring of layer thicknesses, which comprises:
providing a high-frequency probe with a coupling surface having a planar surface region;
wetting a nuclear fuel cladding tube with a coupling medium;
coupling the planar surface region with a wetted surface of the cladding tube by a contact technique; and
measuring a thickness of a liner layer of the cladding tube.

9. The method according to claim 8, which further comprises carrying out the measuring step by measuring a thickness of a liner layer of the cladding tube selected from the group consisting of an inner liner layer and an outer liner layer.

10. The method according to claim 9, wherein the thickness of the liner layer is approximately 0.15 mm.

11. The method according to claim 8, wherein the coupling surface has an overall planar shape.

12. The method according to claim 8, wherein the coupling surface is substantially planar over its entire surface.

13. The method according to claim 8, which further comprises recording echo signals received by the probe in digital form and improving a signal/noise ratio of the recorded digital echo signals by digitally processing the recorded digital echo signals.

14. The method according to claim 8, which further comprises digitally recording echo signals received by the probe and digitally processing the recorded digital echo signals to improve a signal/noise ratio of the recorded digital echo signals.

15. The method according to claim 8, which further comprises carrying out the tube wetting step by wetting a tube having a wall thickness no greater than 1 mm.

16. A method for the ultrasound measuring of layer thicknesses in cladding tubes for nuclear fuel, which comprises:
coupling, by a contact technique, a planar surface region of a coupling surface of a high-frequency probe with a tube surface wetted with a coupling medium.

17. The method according to claim 16, wherein the coupling surface has an overall planar shape.

18. The method according to claim 16, wherein the coupling surface is substantially planar over its entire surface.

19. The method according to claim 16, which further comprises recording echo signals received by the probe in digital form and improving a signal/noise ratio of the recorded digital echo signals by digitally processing the recorded digital echo signals.

20. The method according to claim 16, which further comprises digitally recording echo signals received by the probe and digitally processing the recorded digital echo signals to improve a signal/noise ratio of the recorded digital echo signals.

21. The method according to claim 16, which further comprises carrying out the tube wetting step by wetting a tube having a wall thickness no greater than 1 mm.

22. The method according to claim 16, which further comprises measuring a thickness of a liner layer of a nuclear fuel cladding tube selected from the group consisting of an inner liner layer and an outer liner layer, the thickness of the liner layer being approximately 0.15 mm.
